(19) United States
(12) Patent Application Publication
(10) Pub. No.: US 2016/0144401 A1
(43) Pub. Date: May 26, 2016

(54) METHOD FOR ORIENTING ONE-DIMENSIONAL OBJECTS AND ARTICLES OBTAINED THEREFROM

(71) Applicant: THE UNIVERSITY OF MASSACHUSETTS, Boston, MA (US)

(72) Inventors: Kenneth R. Carter, Hadley, MA (US); Jacob John, Amherst, MA (US)

(21) Appl. No.: 14/733,259

(22) Filed: Jun. 8, 2015

Related U.S. Application Data
(60) Provisional application No. 62/008,727, filed on Jun. 6, 2014.

(51) Int. Cl. B05D 7/24

(52) U.S. Cl. CPC B05D 7/24

(57) ABSTRACT

Disclosed herein is a method comprising dispersing one-dimensional objects in a liquid to form a mixture; and disposing the mixture on a substrate that has channels disposed on it; where the channels are of a width of 4 to 90 percent of the length of the one-dimensional object. Disclosed herein is an article comprising a substrate; where the substrate has channels disposed thereon; each channel being bounded by a wall; and a plurality of one-dimensional objects that are oriented relative to the walls on the substrate; and where the channels are of a width of 4 to 90 percent of the smallest length of the plurality of one-dimensional objects.

### CROSS-REFERENCE TO RELATED APPLICATIONS

This application claims priority to U.S. Non-provisional application having Ser. No. 62/008,727 filed on Jun. 6, 2014, the entire contents of which are hereby incorporated by reference.

### STATEMENT REGARDING FEDERALLY SPONSORED RESEARCH OR SUPPORT

This invention was made with Government support under Grant# CMMI-1025020 awarded by the National Science Foundation. The Government has certain rights in the invention.

### BACKGROUND

This disclosure relates to the orientation of objects that are one-dimensional in shape and to articles made therefrom.

One-dimensional objects which have aspect ratios greater than 5 such as nanotubes, microtubes nanowires, microwires, fibers, nanorods, microrods, whiskers, and the like, are generally bundled or entangled into aggregates or agglomerates when disposed on a surface. It is difficult to separate these objects and to orient them because their high aspect ratios permit them to overlap with one another when they are stored. This overlapping is generally random and often results in entanglements which produce the aggregates and agglomerates. The entanglements make it difficult to separate the one-dimensional objects from one another and to orient them in any particular direction. Even when well dispersed, one-dimensional objects (when dispersed from a carrier solvent) will show random, non-aligned orientation when disposed on a surface.

Orienting one-dimensional objects may be used in a variety of different applications. Oriented one-dimensional objects can find utility in a variety of applications in electronics, conductive plastics, catalysts and the like. It is therefore desirable to find a method of orienting one-dimensional objects.

### SUMMARY

Disclosed herein is a method comprising dispersing one-dimensional objects in a liquid to form a mixture; and disposing the mixture on a substrate that has channels disposed on it; where the channels are of a width of 2 to 90 percent of the length of the one-dimensional object.

Disclosed herein is an article comprising a substrate; where the substrate has channels disposed thereon; each channel being bounded by a wall; and a plurality of one-dimensional objects that are oriented relative to the walls on the substrate; and where the channels are of a width of 2 to 90 percent of the smallest length of the plurality of one-dimensional objects.

Disclosed herein too is a method comprising dispersing one-dimensional objects in a liquid to form a mixture; disposing the mixture on a first substrate that has channels disposed on it; each channel being bounded by pair of walls that are substantially parallel to each other at a first distance “x”; collecting one-dimensional objects that are not contained in the channels from the first substrate; disposing the one-dimensional objects so collected onto a second substrate that has channels disposed on it; each channel being bounded by pair of walls that are substantially parallel to each other at a first distance “y”; where y is greater than x; and collecting one-dimensional objects that are not contained in the channels from the second substrate.

### BRIEF DESCRIPTION OF THE FIGURES

FIG. 1 is a schematic diagram depicting the structure of the patterned substrate;

FIG. 2 depicts the various patterns that can be disposed on the substrate;

FIG. 3 depicts the orientation of the one-dimensional objects on the substrate relative to the walls disposed on the substrate;

FIG. 4 depicts the use of serrated walls on the substrate to improve orientation perpendicular to the walls;

FIG. 5 is a photomicrograph showing random orientation of the one-dimensional carbon nanotubes on an unpatterned substrate;

FIG. 6 is a photomicrograph showing that the carbon nanotubes are oriented perpendicular to the channels on a substrate;

FIG. 7 is a photomicrograph showing that silver microwires are oriented perpendicular to the channels on a substrate;

FIG. 8 shows a method for precising positioning of 1-dimensional nanomaterials on the substrate;

FIG. 9A shows another method for precising positioning of 1-dimensional nanomaterials on the substrate;

FIG. 9B shows yet another method for precising positioning of 1-dimensional nanomaterials on the substrate;

FIG. 10 shows that photolithography can be conducted on nanoimprinted substrate; and

FIG. 11 depicts a trilayer approach for positioning and alignment of 1-dimensional nanomaterials.

### DETAILED DESCRIPTION

Disclosed herein is a method of orienting one-dimensional objects on a substrate surface. The method comprises dispersing the one-dimensional objects on the surface of a substrate that comprises a plurality of channels whose walls are parallel to each other and where the walls are separated by a distance of 4 to 90% of the length of the one-dimensional object. The one-dimensional objects orient in a direction that is approximately perpendicular to the walls of the channel. By changing the shape and direction of the channel, different orientations of the one-dimensional object can be obtained. The orientation of the one-dimensional objects can therefore be controlled by controlling the shape and direction of the channels.

In one embodiment, the oriented one-dimensional objects can be fused together after orientation on the substrate to form a network. The network can then be removed, stored separately and transferred to another object. In another embodiment, the oriented one-dimensional objects can be directly transferred to another object without being fused together.

Disclosed herein too are articles that utilize the oriented one-dimensional objects. The one-dimensional objects have an aspect ratio of greater than or equal to 5. Aspect ratio is defined as the length of the one-dimensional object divided by the diameter. While the objects are described as being one-dimensional, it is possible to use one-dimensional objects that contain small branches.

The one-dimensional objects are so called because they extend substantially in only one-dimension in space. They can have cross-sections that have different geometries such as circular, ellipsoidal, square, triangular or polygonal. The one-dimensional objects can be nanoparticles or microparticles. Nanoparticles (nanotubes, nanowires, nanorods, whiskers, and the like) are those that have average diameters of less than or equal to 100 nanometers. Microparticles (microtubes, microrods, microwires, whiskers, and the like) are those that have average diameters of greater than 100 nanometers and less than 10,000 nanometers. When the one-dimensional object does not have a circular cross-sectional area, a diameter of a circle that encompasses all the corners of the object is used as a measure of its diameter.

The aspect ratio of the one-dimensional objects is greater than or equal to about 5, preferably greater than or equal to about 10, preferably greater than or equal to about 15, preferably greater than or equal to about 25, preferably greater than or equal to about 50, preferably greater than or equal to about 100, and more preferably greater than or equal to about 1000. The one-dimensional objects can have lengths greater than or equal to about 100 nanometers, preferably greater than or equal to about 200 nanometers, preferably greater than or equal to about 500 nanometers, preferably greater than or equal to about 1000 nanometers, preferably greater than or equal to about 2000 nanometers, preferably greater than or equal to about 3000 nanometers, preferably greater than or equal to about 5000 nanometers, and more preferably greater than or equal to about 10000 nanometers.

Examples of the one-dimensional objects are nanotubes, microtubes nanowires, microwires, fibers, nanorods, microrods, whiskers, or the like, or a combination of one of the foregoing one-dimensional objects.

The one dimensional objects can comprise inorganic materials or organic materials. Inorganic one-dimensional objects include those comprising elemental metals, metal alloys, metal oxides, metal sulfides, metal nitrides, metal borides, metal silicides, metal phosphides, metal carbides, or the like, or a combination comprising at least one of the foregoing inorganic materials. Organic one-dimensional objects include carbon nanotubes, carbon nanotubes having pendant organic or inorganic substituents, nucleic acids (e.g., DNA, RNA, or the like), polymeric fibers (e.g., polyacetylenes, polyacrylates, polyesters, polystyrenes, polycarbonates, polyimides, polyetherimides, polyetheroxides, polyether ketones, polysiloxanes, polyfluoroethylenes, cellulose, or the like), or the like, or combinations comprising at least one of the foregoing.

Examples of one-dimensional nanosized or microsized objects are carbon nanotubes (single wall, multiwall, double wall nanotubes), nanotubes or nanowires or nanorods comprising molybdenum, silicon, boron nitride, tungsten disulfide, tin disulfide, vanadium oxide, aluminum oxide, titanium oxide, zinc oxide, manganese oxide, transition metal/chalcogen/halogenides (TMCH), described by the formula TM₆C_{y}H_{z}, where TM is a transition metal (e.g., molybdenum, tungsten, tantalum, niobium), C is a chalcogen (e.g., sulfur, selenium, tellurium), H is halogen (e.g., iodine), and where 8.2<(y+z)<10, polyacetylene nanowires or microwires, polyacrylate nanowires or microwires, polyester nanowires or microwires, polystyrene nanowires or microwires, polycarbonate nanowires or microwires, polyimide nanowires or microwires, polyetherimide nanowires or microwires, polyetheroxide nanowires or microwires, polyether ketone nanowires or microwires, polysiloxane nanowires or microwires, polyfluoroethylene nanowires or microwires, cellulose nanowires or microwires, or the like. One-dimensional composites (e.g., polymeric nanowires coated with metals or metal oxides, polymeric nanowires filled with carbon black or silica, carbon nanotubes intercalated with metals or metal oxides, or the like) are also contemplated. The aforementioned one-dimensional objects are prefaced by the term “nano”, but may also be present in the micrometer range as detailed above. Exemplary one-dimensional objects are carbon nanotubes.

The channels upon which the one-dimensional objects are disposed are themselves disposed upon a substrate. Any material may be used as a substrate, so long as the channels are capable of being disposed on it. They may be silicon wafers, polymeric substrates (e.g., films, sheets, fibers, or the like), paper, metal substrates, ceramic substrates, oxides, glass, cloth substrates or the like.

The substrate and the channels disposed thereon can be naturally occurring or manufactured synthetically. Examples of naturally occurring substrates can be animal skins, where the hair (fur) acts to form channels and the skin is the substrate. Other examples are fish skins (scale patterns that have a particular orientation), tree leaves, flowers, insect wings, bark of trees, or the like.

In one embodiment, the substrate can comprise a naturally occurring material, while the channels comprise a synthetically manufactured material. In another embodiment, the substrate can comprise a synthetically manufactured material, while the channels can comprise a naturally occurring material.

The channels (and the substrate) may also be synthetically manufactured. This can occur by disposing channels on the substrate by methods involving by nanoimprinting, roll-to-roll ultraviolet nanoimprinting, laser printing, embossing, lithography followed by etching, self-assembly of a copolymer followed by etching; photolithography followed by etching; surface wrinkling, creasing or buckling, nano-scribing, scratching, shadow deposition, transfer printing, interference lithography, immersion lithography, atomic force microscopy lithography, e-beam lithography, nano-scribing, or a combination thereof. The walls of the channels are raised above the surface of the substrate or alternatively, the channels can be embedded into the substrate. In one embodiment, a block copolymer that comprises a lamellar or cylindrical morphology may be disposed upon the substrate and one of the phases of the block copolymer may then be etched away leaving the channels upon which the one-dimensional objects are disposed. Other techniques not disclosed here may also be used.

In an embodiment, the substrate is a silica wafer used in semiconductors.

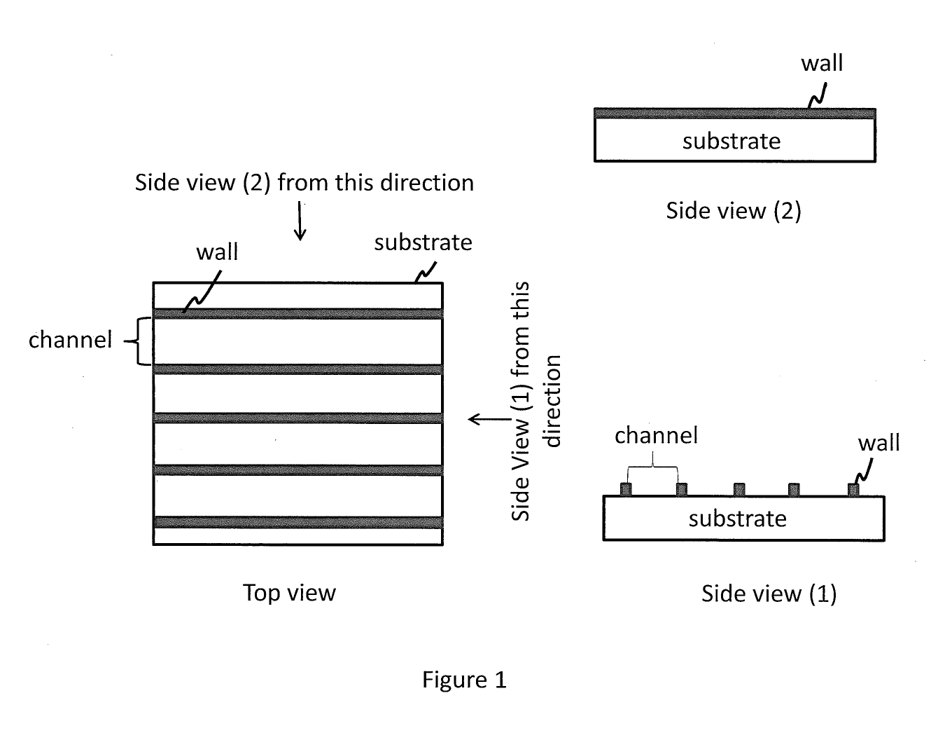

FIG. 1 is an image that shows a top view and side view of the channels that are disposed on the substrate (i.e., a patterned substrate). As seen in the FIG. 1, the channels may be parallel to each other. The channels are formed by walls that are disposed upon the substrate. When the one-dimensional objects are disposed upon the substrate, they are supported by the walls. It is therefore desirable for the walls to be spaced apart at distances that are shorter than the shortest length of the one-dimensional object.

While the FIG. 1 shows that the upper wall surfaces are parallel to the substrate, the upper wall surfaces may be serrated in order to facilitate improved orientation of the one-dimensional objects perpendicular to the walls. In other words, the upper wall surfaces need not be parallel to each other.

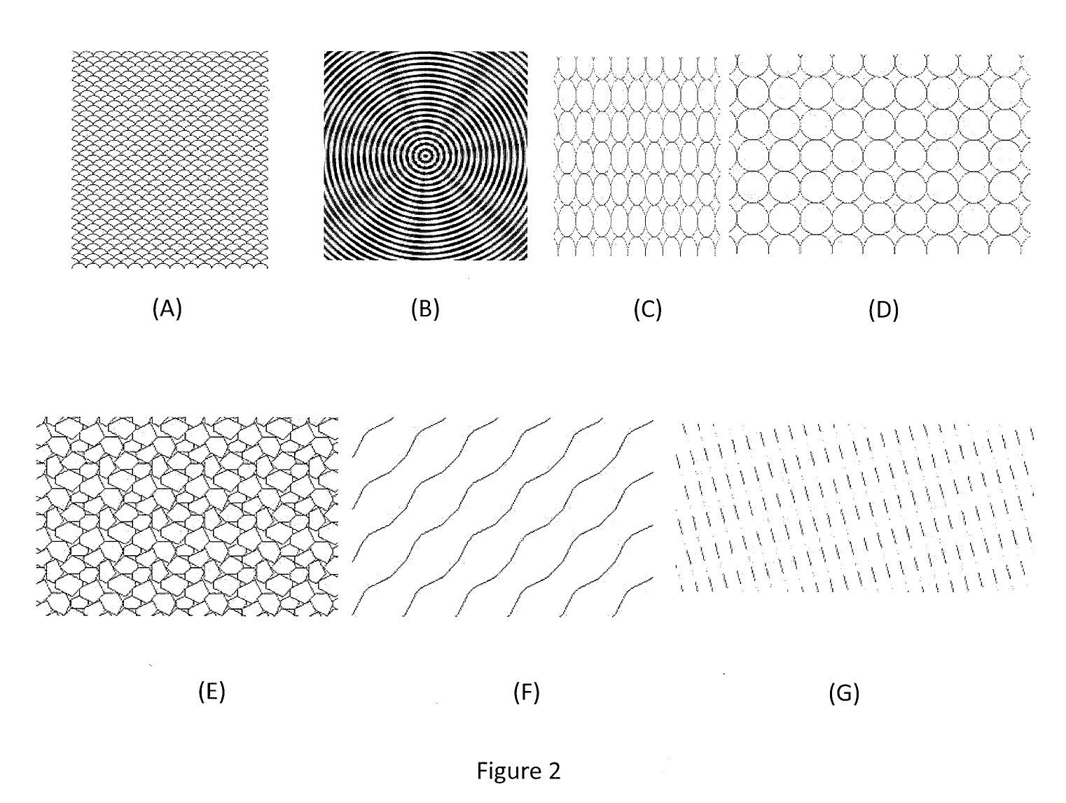

Alternatively, the channels may be disposed on the substrate in patterns that are not parallel. Examples of these patterns are shown in the FIG. 2. FIGS. 2 (A) through 2 (G) show a variety of non-limiting patterns for the channels that may be used to orient the one-dimensional objects. FIG. 2 (A) shows semi-circles that abut one another. FIG. 2 (B) show concentric circles, while FIGS. 2 (C) and (D) (will not align 1D objects) show ellipsoids and circles that abut each other respectively. FIG. 2 (E) shows irregular shapes (e.g., polygons) that abut each other. FIG. 2 (F) depict channels that have curved walls, where the channels are parallel to each other. FIG. 2 (G) shows channels that are intermittent.

In all of the different patterns depicted in the FIG. 2 (A) through (G), it is desirable for the walls that form the pattern to be spaced at distances that are smaller than the shortest length of the one-dimensional object. As noted above, it is generally desirable for the walls that support the one-dimensional object to be parallel to each other.

FIGS. 2(H) through 2 (P) show additional patterns that may be used on a surface. FIGS. 2 (H) and 2(I) shows patterns that have channels that are parallel to each other but on different planes. The use of such channels will allow for the formation of two and three dimensional networks of one-dimensional objects (if the one-dimensional objects) are fused together after being disposed on the substrate. FIGS. 2(J) through 2 (P) show various patterns that include using channels that have walls made of beads (2(J), wires (2(K), and walls of various shapes. As can be seen from the FIGS. 2 (J) through 2(P), the channels can be sinusoidal, saw tooth, square wave, and the like. Channels can be symmetrical or asymmetrical about an axis if so desired.

It is to be noted that by using successively disposing the one-dimensional objects on different substrates having channels that are differently spaced on the different substrates, the one-dimensional objects may be fractionated into different groups having different lengths. For example, by disposing a first substrate having wall spacing of “x” nanometers, one-dimensional objects having a length of less than “x” can be separated from those having a length greater than “x”. By collecting the one-dimensional objects having lengths greater than “x”, and disposing them on a substrate having walls spaced apart at a distance “y” nanometers (where y is greater than x), one-dimensional objects having a length between x and y can be separated from the sample. By successively increasing the wall spacings of the substrate that the one-dimensional objects are disposed on, the objects can be fractionated into a series of samples having different lengths. This method can be used to produce a series of monodisperse one-dimensional samples.

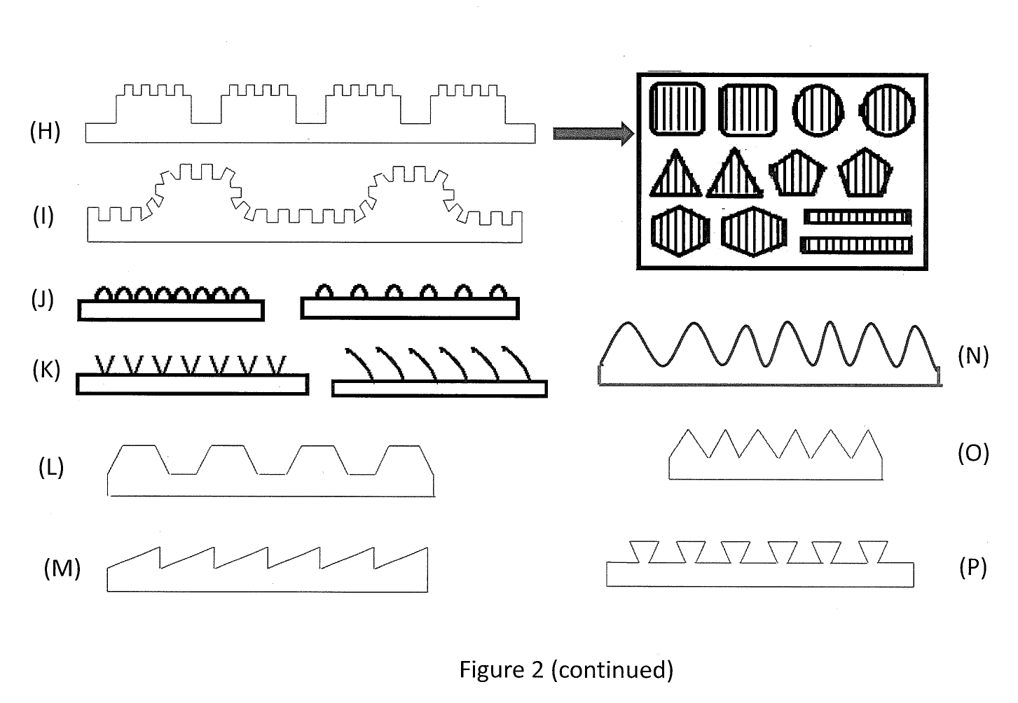

The FIG. 3 is a schematic depiction of one-dimensional objects that are disposed on the channels of the FIG. 1. As can be seen in the FIG. 3, the one-dimensional objects do not end up being parallel to the walls but end up being perpendicular (or approximately perpendicular) to the walls. The perpendicular orientation is brought about by the evaporation of the solvent in which the nanotubes are dispersed prior to being disposed upon the patterned substrate. The channels influence the direction of the moving triple contact line (solid-liquid-air interface) during the evaporation of the carrier material/solvent. This will be detailed later.

The one-dimensional objects are oriented approximately perpendicular to the walls, when the upper surface of the walls are parallel to the substrate surface. There is some variation in the perpendicularity of the objects with relationship to the walls. This variation is indicated by the angle α in the FIG. 3. The angle α on either side of the perpendicular to the walls can range from 1 to 40 degrees, preferably 2 to 25 degrees, and more preferably 3 to 20 degrees.

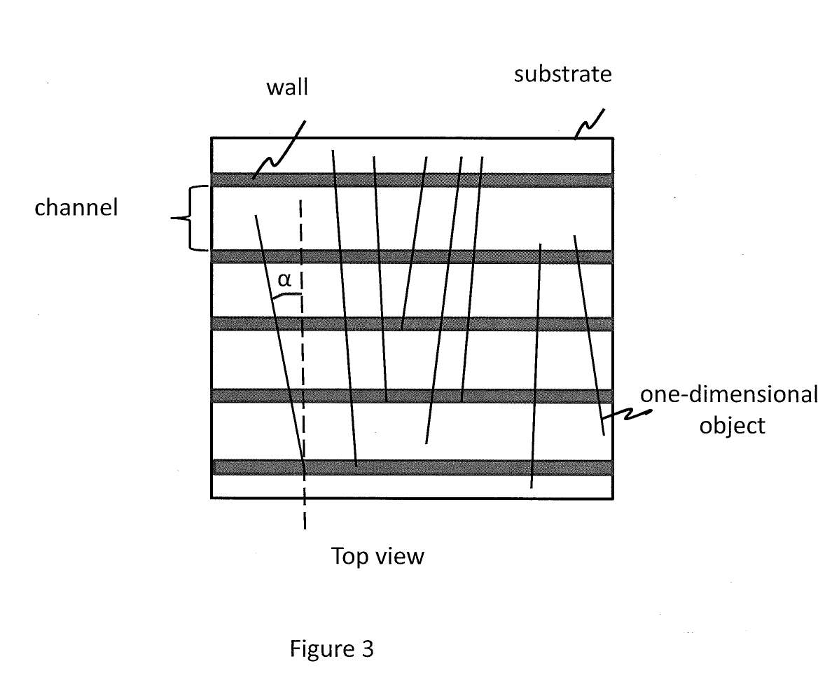

In one embodiment, the orientation of the one-dimensional objects can be improved by using channels that are bounded by serrated walls as shown in the FIG. 4. The serrations will permit the one-dimensional object to perfect their alignment because of the effect of gravity. Other fields such as flow, electrical, magnetic, electromagnetic fields can be used to improve orientation of the one-dimensional objects on the substrate.

The walls that bound the channels are spaced at 2% to 90% (i.e., the distance between the walls is 2% to 90%), preferably 4% to 50%, and more preferably 6% to 30% of the average length of the one-dimensional object.

In one embodiment, in one method of aligning the one-dimensional objects on the channels disposed on the substrate, the one-dimensional objects are first dispersed in a liquid. The liquid should not completely solubilize the one-dimensional object. It may however, partially solubilized the one-dimensional object. The liquid can be polar or non-polar. The liquid can contain dissolved polymers as thickeners.

Exemplary liquids are water, alcohols, ketones, glycol ethers, propylene carbonate, ethylene carbonate, butyrolactone, acetonitrile, benzonitrile, nitromethane, nitrobenzene, sulfolane, dimethylformamide, N-methylpyrrolidone, nitromethane, methanol, ethanol, propanol, isopropanol, butanol, benzene, toluene, methylene chloride, carbon tetrachloride, hexane, diethyl ether, tetrahydrofuran or the like, or combinations comprising at least one of the foregoing liquids. Polymeric emulsions may also be used to disperse the one-dimensional objects. While the liquid-one-dimensional object mixture is termed a dispersion, there is no requirement for the one-dimensional objects to be suspended in the liquid. It is sufficient for the one-dimensional objects to be present in the liquid in the form of a mixture.

The one-dimensional objects are then dispersed in the liquid to form the dispersion. The amount of liquid in the dispersion may be in an amount of 50 to 10000, preferably 75 to 5000, and more preferably 100 to 1000 weight percent of the total weight of the one-dimensional objects contained in the dispersion.

After preparing the dispersion, the substrate may be patterned to form the channels depicted in the FIGS. 1-3. The dispersion may then be disposed on the patterned substrate by spray painting, brush painting, dip coating, drop casting, electrostatic spray coating, doctor blading, gravure coating, rod coating, slot-die coating, spin coating, or the like, or a combination thereof. After disposing the dispersion on the patterned substrate, the substrate with the one-dimensional objects disposed thereon may be subjected to drying at room temperature or at elevated temperatures. Elevated temperatures are generally chosen depending upon the liquid used. For example, if water is the liquid, a temperature of 60 to 150° C. may be used. In general, the temperatures used are 15 to 350° C. The substrate with the dispersion disposed thereon may be heated using conduction, convection or radiation. In another embodiment the dispersion may be disposed on preheated patterned substrates. The temperature of the pre-heated substrate can be 15 to 350° C.

After, heating the substrate to rid the substrate of solvent, the aligned one-dimensional objects may be collected from the surface using a transfer technique. For example, an adhesive surface can be used to contact the oriented one-dimensional objects to transfer them to the adhesive surface. In another embodiment, a second heated polymeric substrate (in the form of a film or a fiber) may be used to contact the oriented one-dimensional objects thus causing them to adhere to the surface of the second heated polymeric substrate. The second heated polymeric substrate may be heated to a temperature proximate to its softening point (i.e., its glass transition temperature or melting temperature depending upon percent crystallinity).

In one embodiment, the patterned substrate (having the channels) may be heated to fuse the oriented one-dimensional objects to the walls to produce a reinforced article. In another embodiment, the patterned substrate may be heated to fuse the oriented one-dimensional objects to each other to form a two-dimensional network. The network can then be transferred to other substrates for use.

The oriented one-dimensional networks can be used to produce conducting networks for use in electronics, plastics, to produce surface conductivity or magnetism in other insulating materials.

The method and the articles disclosed herein are exemplified by the following non-limiting example.

### EXAMPLE

This example demonstrates the methods disclosed herein. It shows how one-dimensional objects (carbon nanotubes) may be preferentially oriented on a patterned substrate. The substrate is a polyester substrate.

A polyester (polyethylene terephthalate) substrate was first patterned using roll-to-roll UV nanolithography. UV curable hydrophilic resists such as Bomar TM XR-9416 from Dymax, CT or thiolene based UV resists can be used to pattern the polyester substrate. The channel width was 70 nanometers and the pitch between channels was 140 nanometers. The pitch here refers to the distance between the centerline of one wall and a neighboring wall.

Carbon nanotubes were dispersed in deionized water in an amount of approximately 0.01 weight percent, based on the total weight of the carbon nanotube-water dispersion.

The carbon nanotube-water dispersion was then disposed on the patterned polyester substrate and heated to a temperature of 115° C. to rid the substrate of the water. The nanotubes were dispersed using one of two techniques—Mayer rod coating technique or a spray coating technique. The carbon nanotube dispersion was applied on patterned substrate at room temperature as well as on preheated patterned substrates.

The carbon nanotube-water dispersion was then disposed on a non-patterned polyester substrate and heated to a temperature of 115° C. to rid the non-patterned substrate of the water.

All substrates with the nanotubes disposed thereon were examined under a scanning electron microscope.

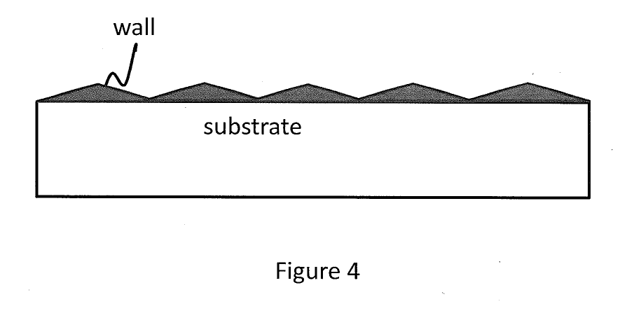

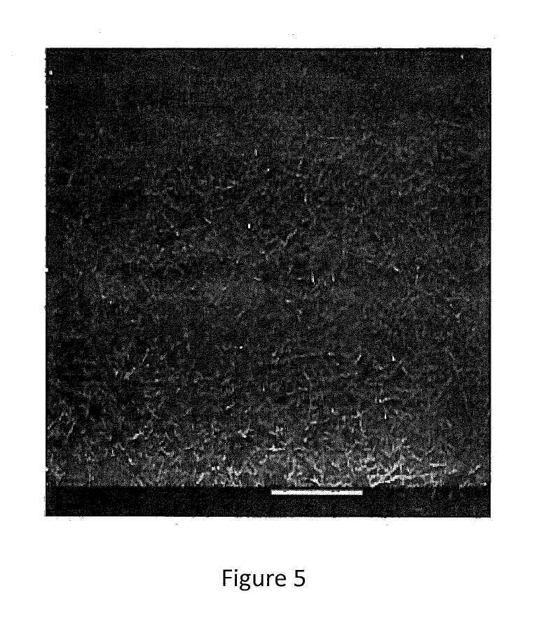

The non-patterned substrate with the nanotubes disposed thereon is shown in the photomicrograph in the FIG. 5, while the patterned substrates having different orientations are shown in the FIG. 6. In the FIG. 5, it may be seen that the nanotubes are randomly oriented.

The FIG. 6 shows that the nanotubes are oriented approximately perpendicular to the channels on the patterned substrate. It can also be observed that the nanotubes are disentangled and oriented perpendicular to the channels on the patterned substrate. This demonstrates that the presence of channels facilitates orientation of the one-dimensional objects on the substrate.

### Example 2

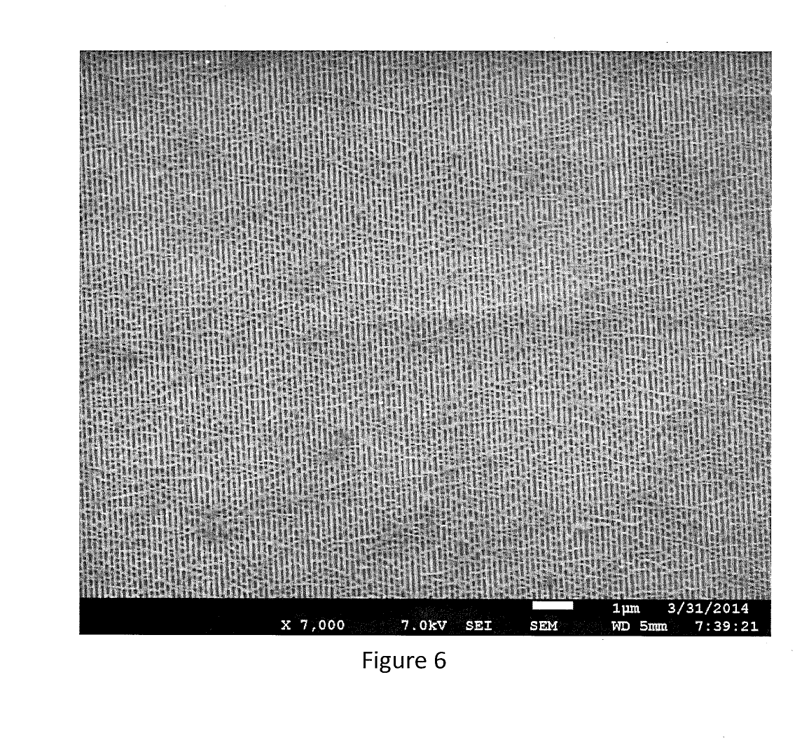

This example was conducted to demonstrate that other one-dimensional fibers can also align themselves perpendicular to the channels that are disposed on a substrate. The silver microwires dispersed in ethanol (concentration—8 mg/mL) is disposed on preheated substrates (105-115 degree Celsius) having channels on it. The width of the channel used in this case was 850 nanometers. Since the mixture was disposed on a substrate that was preheated to 105-115 degree Celsius, the carrier ethanol evaporated immediately. The silver microwires oriented perpendicular to the channel direction as seen in the SEM image in the FIG. 7.

Transistors and diodes: A major challenge facing the integrated circuit industry is that the conventional top-down techniques, which have been the methods of choice for decades have reached their limits. At the same time, the industrial demand for smaller electronic devices of high functional complexity generated intensive efforts for new solution based bottom-up strategies. One of the biggest challenges facing the electronic industry in this area is the lack of a simple, low cost and scalable technique to precisely position and align 1D nanomaterials (NMs) in desired locations as well as controlled assembly and integration of nanostructures into functional device arrays. These handicapping limitations keep challenging the world in the search for new assembly solutions. The new alignment technique reported by us enables precise positioning and orientation of 1D nanomaterials (NMs) in desired locations on any substrate of choice. Our technique is simple, scalable and do not require complicated instrumental set up.

We claim that the effective utilization of our technique will lead to the commercialization of a large number of high performance electronic devices based on 1D NMs. The 1D NMs can be deterministically positioned and oriented using our technique by generating the pattern using a 3D mold (or using any other 3D structure generation lithographic technique) in which the patterned areas on the substrate are slightly elevated (hundreds of nanometers to tens of microns or millimeters) than the normal substrate surface plane (see FIG. 1). The 1D NM dispersion can then be disposed on the substrate to align. Afterwards, the aligned assembly can be transfer printed on to a different substrate of choice in which only the aligned 1D NM assembly on the elevated patterned area will be transferred, whereas the rest will remain on the original substrate, as it will not come into contact with the second substrate. Transistors and diodes are the basic components for electronic circuits. The 1D NMs are being extensively used by researchers in the fabrication of the above mentioned devices. It has been previously shown that the field effect transistors (FETs) fabricated using horizontally aligned 1D nanomaterials (nano/micro-tubes and wires) showed higher performance than those made using randomly oriented 1D NMs. Aligned nanomaterials provide direct conduction paths between source (S) and drain (D), while presence of many junctions in randomly oriented network leads to reduced conductance. Higher mobility, high on/off ratio, high current and high frequency performance are some of the many advantages reported for FETs fabricated using horizontally aligned 1D NMs. Significant progress has been achieved in the practical implementation of SWCNTs in high speed analog circuits. RF analog electronic devices based on aligned SWCNTs were reported by Roger and co-workers. They constructed narrow band amplifiers and SWCNT radio in which the aligned SWCNTs devices provide all of the key functions including resonant antennas, fixed RF amplifiers, RF mixers and audio amplifiers. Researchers also looked into the possibility of building digital circuits such as logic gates based on nanotube transistors. Liu and co-workers fabricated a truly integrated CMOS logic inverter based on horizontally aligned nanotube array transistors. The aligned 1D NMs obtained by our technique can be used to fabricate photodiodes and transistors for image sensor circuitry as well. The invented alignment technique can thus be directly utilized to fabricate all integrated image censor circuit. The alignment technique can be effectively utilized to make high performance transistors based on 1D Nanomaterials. Our technique can also be utilized in the fabrication of digital circuits, nanoprocessors, wireless devices and its components, antennas and devices where horizontally aligned ID NMs are an integral part of the device. The devices can be directly fabricated on the aligned 1D nanomaterial substrate or the aligned 1D nanomaterials can be transferred to a substrate of choice for device fabrication, integration as well as for making interconnects. The invention of this new alignment technique has opened a simple route for low cost large area high volume fabrication of transistors and optoelectronic devices based on 1D NMs. We also claim that our technique can also be used along with other commonly used techniques to solve and overcome challenges related to substrate preparation, positioning and orientation, fabrication, integration and mass production (including roll-to-roll) of various similar electronic and optical devices.

Memory, Logic devices and integration of devices: The invented alignment technique can be used for fabricating memory devices based on 1D nanomaterials. The memory device can be fabricated on the substrate where 1D NMs are aligned or on a substrate of choice by transfer printing the aligned 1D NMs in preferred locations and orientation. The ability to transfer the aligned 1D NMs obtained by our technique offers a powerful route for constructing logic devices. It was shown by researchers that CMOS inverters can be developed without complex interconnects using ultralong SWCNTs. Moreover, the ability to control the direction of orientation of the 1D NMs in desired locations as well as the ability to transfer to another substrate of choice without disturbing the orientation of 1D NMs offers a unique and simple route towards integration of devices. We claim that our technique will have certain applications in the area of making interconnects. We also claim that the combination of our technique along with other commonly used technique or techniques in the integration of devices and making interconnects will solve the existing challenges facing this area, including issues related to the mass production of devices.

Light Emitting Diodes (LEDs): The invented alignment technique can be directly applied to fabricate horizontally aligned 1D NM based LED devices.

Biological and medical devices: Devices based on nanowires are emerging as a powerful and general platform for ultrasensitive, electrical detection of biological and chemical species and the ongoing research in the area promises to yield revolutionary advances in healthcare, medicine and life science. The tunable conductive properties of semiconducting nanowires combined with surface binding offers a powerful tool for detection and sensing applications in medicine and life sciences. Silicon nanowire and CNT based FETs are proven to be an efficient tool in biosensor applications because of their ultrasensitivity, selectivity, and label free and real-time detection capabilities. They are employed in the detection of proteins, DNA, RNA, small molecules, cancer biomarkers, asthma, viruses and bacteria. They are also used in recording physiological responses from cells and tissues as well as for recording intracellular signals. These biosensors can be enzyme modified FETs, cell based FETs and immunologically functionalized FETs. The 1D NMs such as CNTs, organic and inorganic nanowires have been used as candidates for the development of biomedical devices. The alignment and assembly of these NWs are essential for the fabrication of most of these biomedical and biosensing devices. The alignment technique we developed can be effectively utilized in the fabrication of each of these devices. We believe that the abilities to precisely control the orientation of 1D NMs in a predetermined position and transferring them to another substrate of choice will solve the bottle-neck issues related to fabrication, integration and mass production of these devices. The FETs based on aligned array of 1D NMs and aligned array of 1D NM itself can be a part/component of the device used for these applications such as microfluidic devices, lab on a chip devices, sensing and diagnostic devices and the like. The device applications also include sensing glucose, detecting biochemical agents or cellular response from living cells, action potentials from neuron cells, electrical recording from organs, detecting DNA, RNA, antigens, cancer markers, bacterial and virus infections, micro RNAs for early diagnosis of cancer and the like. The devices can also be used to study peptide-small molecule interactions, protein-protein interactions, protein-small molecule interactions and the like. The horizontally aligned 1D NM array prepared by our technique can be a part of microfluidic devices for various sensing/detection applications. Our technique can be easily used for integrating such arrays into microfluidic and other wearable health monitoring devices used in medical fields. We also claim that our technique can also be used along with other commonly used techniques to solve and overcome challenges related to substrate preparation, positioning and orientation, fabrication, integration and mass production (including roll-to-roll) of various similar electronic and optical biomedical devices and sensors.

Flexible and stretchable bio-integrated electronic devices: The alignment technique we developed can be readily applied to fabricate electronic and optoelectronic devices that have the ability to flex and stretch, even to large levels of deformation that will enable conformal wrapping onto a suitable curved surface as well as laminate onto a soft, moist curvilinear tissues with robust adhesion (organs) for electrophysiological analysis. We also claim that our technique can also be used along with other commonly used techniques to solve and overcome challenges related to substrate preparation, positioning and orientation, fabrication, integration and mass production (including roll-to-roll) of various similar electronic and optical biomedical devices and sensors.

Chemical, Biological and Physical sensors: Our technique can be used to align 1D nanomaterials for the fabrication of various physical, chemical, biological and environmental sensors. Other sensors that can be fabricated include, strain sensor, pressure sensor, gas sensor, electromagnetic radiation sensors, heat sensors, motion sensors, micro fluidic sensors and the like. We also claim that our technique can also be used along with other commonly used techniques to solve and overcome existing challenges related to substrate preparation, positioning and orientation, fabrication, integration and mass production (including roll-to-roll) of similar sensor devices.

Polarizer and Polarized Light Source: The density of the aligned 1D NMs obtained using our technique can be increased by transfer printing different aligned regions of the patterned substrate multiple times on to the same area on the receiving (second) substrate. This repeated transfer printing can thus be used to generate horizontally aligned array of 1D NMs of desired density. The aligned nano-tubes or wires made using the technique we developed can be used for making optical polarizers, optical filters and polarized light sources. Polarizers that can be made using our technique can work at wavelength ranging from deep UV to terahertz (THz). When a current is applied through the aligned nanotubes or nanowires or the likes, photons will be emitted which will be polarized along the tube/wire axis. Polarized light source and polarized incandescent light source can be constructed using the 1D NMs aligned by our technique. We also claim that our technique can also be used along with other commonly used techniques in this area to solve and overcome challenges related to substrate preparation, positioning and orientation, fabrication, integration and mass production (including roll-to-roll) of similar devices.

Liquid Crystal Alignment Layers and Transparent Electrodes: The aligned CNTs can be used as an alignment layer for aligning liquid crystals. The same was also been utilized as conducting transparent electrodes for device applications such as display units and touch screen/panel applications. The aligned 1D NMs (CNTs, and the like.) also enable the fabrication of flexible and curved touch screens and touch sensors. CNT based products in this area were proved to be much better than ITO touch screen in scratch resistance and endurance tests. Aligned 1D NMs made utilizing our technique can also be used in the fabrication of the above mentioned devices. We also claim that our technique can also be used along with other commonly used techniques in this area to solve and overcome existing challenges related to substrate preparation, positioning and orientation, fabrication, integration and mass production (including roll-to-roll) of similar devices.

Flexible stretchable transparent loudspeakers: Aligned CNTs and the likes obtained by our method can be used to fabricate flexible, stretchable, transparent and magnet free loud speakers as well as other acoustic devices. We also claim that our technique can also be used along with other commonly used techniques in this area to solve and overcome challenges related to preparation, positioning and orientation, fabrication, integration and mass production (including roll-to-roll) of similar devices.

Energy Harvesting devices, nanogenerators and the like. Piezoelectric characteristics of certain 1D NMs (e.g. ZnO nanowires) are being effectively utilized for energy harvesting purposes. These 1D NMs have to be aligned either vertically or horizontally during the fabrication of the device. It has been shown that high-output flexible nanogenerators can be made from lateral array of ZnO nanowires. Our technique can be utilized in the fabrication of similar devices. The piezoelectric 1D NMs can be aligned by our technique for fabricating energy harvesting devices including wearable and stretchable devices. These devices can also be embedded in biocompatible materials for providing power for medical implants. We also claim that our technique can also be used along with other commonly used techniques in this area to solve and overcome challenges related to substrate preparation, positioning and orientation, fabrication, integration and mass production (including roll-to-roll) of similar devices.

Metamaterials: The alignment technique detailed herein can be used in the fabrication of metamaterials with advanced properties and stacks of 3D structures having advanced optical and electronic properties in which horizontally aligned array of 1D NMs are components or part of the device. We also claim that our technique can also be used along with other commonly used techniques in this area to solve and overcome challenges related to substrate preparation, positioning and orientation, fabrication, stalking multiple layers, integration and mass production (including roll-to-roll) of similar devices and complex structures with advanced properties.

Artificial Muscles: The aligned CNT films can be used as artificial muscles that are driven by an applied voltage and can provide large elongations and elongation rates. Our technique can also be used to make horizontally aligned 1D NM based artificial muscles. We also claim that our technique can also be used along with other commonly used techniques in this area to solve and overcome challenges related to preparation, positioning and orientation, fabrication, integration and mass production (including roll-to-roll) of artificial muscle or components.

Cross-stack film of aligned 1D NMs: Cross-stack film of 1D NMs can be made by transfer printing aligned 1D NMs obtained using our technique in orthogonal directions. The aligned 1D NM film as well as cross-stack film can be used as electrodes for lithium ion batteries and supercapacitors and capacitors. We also claim that our technique can also be used along with other commonly used techniques in this area to solve and overcome challenges related to substrate preparation, positioning and orientation, fabrication, integration and mass production (including roll-to-roll) of similar devices.

Surface Enhanced Raman Spectroscopy substrates (SERS): Due to the presence of large electromagnetic fields, a film of well aligned Ag NWs can be used as an excellent SERS substrate for molecular sensing with high sensitivity and selectivity. The 1D NMs aligned using the technique we developed can also be used for making SERS substrate. The cross-stacks of CNT films can also be used as SERS substrate. We also claim that our technique can also be used along with other commonly used techniques in this area to solve and overcome challenges related to substrate preparation, positioning and orientation, fabrication, integration and mass production (including roll-to-roll) of similar substrates.

Composite materials: The alignment technique we developed can be used to develop composite materials with excellent mechanical and physical properties for practical applications. Composite materials with aligned tubes, wires or fibers embedded in it can also show improved mechanical and electrical properties along the direction of the orientation of 1D NMs or fiber materials. These composites can be used as materials for practical applications such as electrostatic dissipation and electromagnetic interference shielding. We also claim that our technique can also be used along with other commonly used techniques in this area to solve and overcome challenges related to preparation, positioning and orientation, fabrication, and mass production (including roll-to-roll) of similar engineering composite materials.

Miscellaneous applications: The alignment technique can be used for developing various nano and micro filters made of horizontally aligned array of 1D NMs for various filtration applications in engineering and medical fields. The filtrate can be particulates or chemical species in air or liquid, bodily fluids, oils and the like. We also claim that our technique can also be used along with other commonly used techniques in this area to solve and overcome challenges related to preparation, positioning and orientation, fabrication, integration and mass production (including roll-to-roll) of similar filtration devices.

One of the biggest challenges facing the electronic industry in this area is the lack of a simple, low cost and scalable technique to precisely position and align 1D nanomaterials (NMs) in desired locations as well as controlled assembly and integration of nanostructures into functional device arrays. These handicapping limitations keep challenging the world in the search for new assembly solutions. It is therefore desirable to devise methods that permit the precise alignment of 1-dimensional nanomaterials on substrates. Such substrates with conductive nanomaterials located in precise positions can be used in some of the devices mentioned above.

The invention disclosed herein enables precise positioning and orientation of 1D nanomaterials (NMs) in desired locations on any substrate of choice. The technique is simple, scalable and do not require complicated instrumental set up. The technique disclosed herein can not only be used to horizontally align/orient 1D Nanomaterials (NMs), but also to assemble, precisely position and horizontally align/orient 1D NMs in preferred or predetermined locations on any substrate of choice.

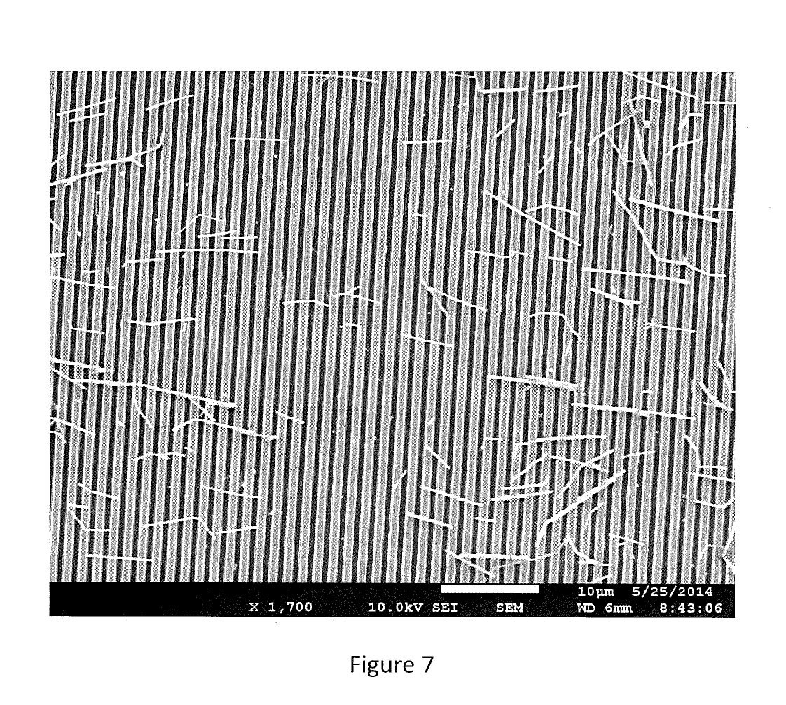

The 1D NMs can be deterministically positioned and oriented by generating a pattern on the substrate using a mold having three dimensional patterns (3D master mold) (or using any other 3D structure generation lithographic technique) in which the patterned areas on the substrate are slightly elevated (hundreds of nanometers to tens of microns or millimeters) than the normal substrate surface plane (see FIG. 8). In the FIG. 8, a pattern is first disposed onto a substrate 10 creating ridges 12 that are elevated above the base surface of the substrate 10. These ridges create the channels (see the structure on the left). The 1D NM dispersion is then disposed on the substrate and aligns substantially perpendicular to the channels (see center). Following this, the aligned assembly can be transferred to a second substrate 20 of choice via transfer printing in which only the aligned 1D NM assembly on the elevated patterned area will be transferred, whereas the rest will remain on the original substrate, as it will not come into contact with the second substrate.

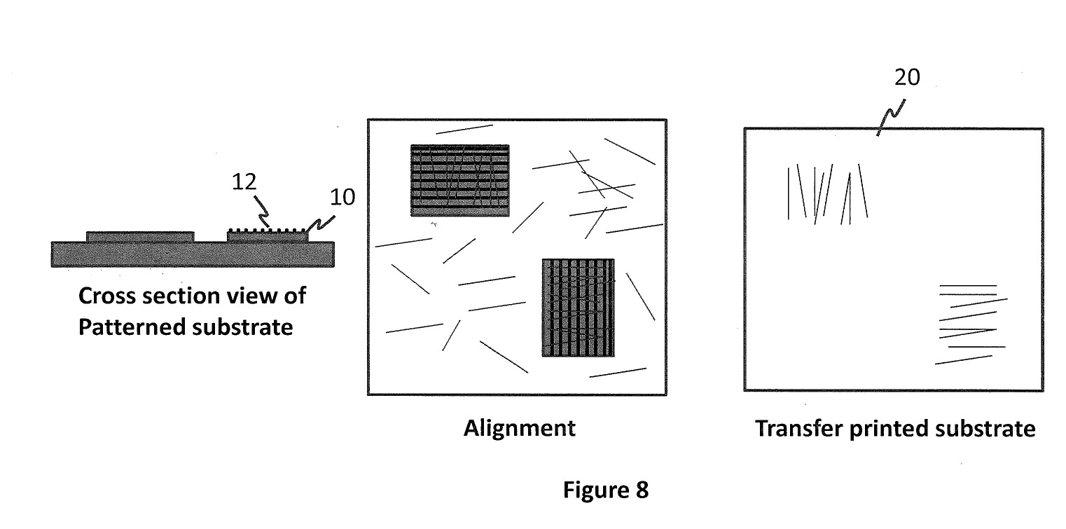

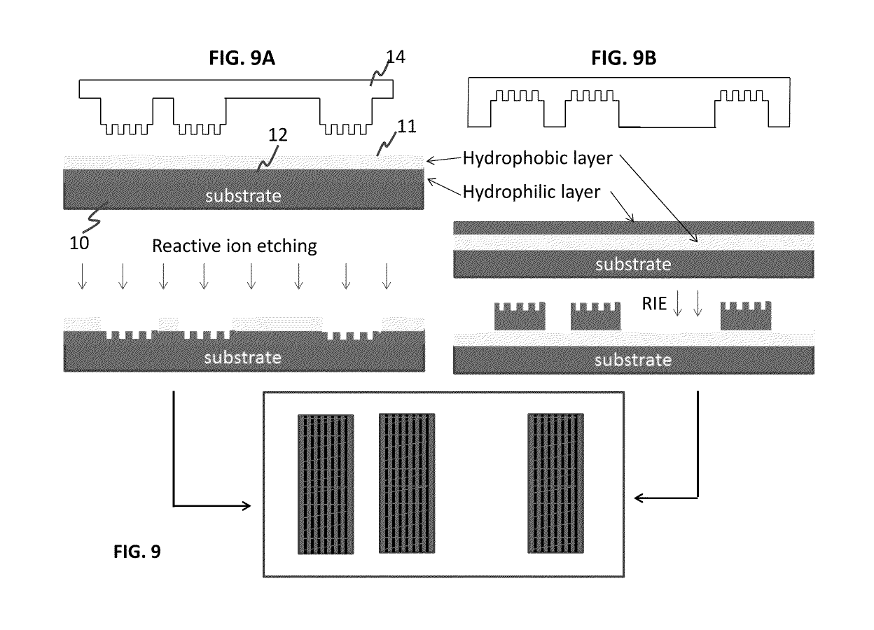

Another embodiment of the method of disposing nanomaterials on a substrate is shown in the FIGS. 9A-9B. This method uses a bi-layer approach. In the FIG. 9A, a substrate 10 has sequentially disposed upon it a hydrophilic layer 11 and a hydrophobic layer 12. The hydrophobic and hydrophilic layers can be interchanged (See FIG. 9B). A mold 14 having an image of the desired ridges is pressed into the substrate (with the hydrophilic and hydrophobic layers) to form an impression of the ridges in the hydrophilic layer. The mold is then removed by etching leaving behind the ridges in either the hydrophobic layer or the hydrophilic layer as desired. In the FIG. 9A, the ridges are disposed in the hydrophilic layer, while in the FIG. 9B (which uses the same method) the ridges are disposed in the hydrophobic layer. The etching used may be chemical etching or reactive ion etching.

Following the etching to produce the ridges, a dispersion containing the 1-dimensional nanomaterials is disposed on the surfaces of the ridges and undergoes alignment as heretofore detailed.

After transferring the pattern on the mold to the hydrophobic layer (via imprinting or other techniques as shown in the FIG. 9A), the pattern is transferred to the underlying layer via reactive ion etching process (RIE) in the case shown in FIG. 9A. In the case shown in FIG. 9B, a RIE process has to be done for a very short duration to remove any residual layer to expose the underlying layer. In this case (see FIG. 9B), the imprinted pattern do not need to be transferred to the underlying layer. After an oxygen plasma etching process or a similar process for transferring the pattern to the underlying layer or for exposing the underlying layer, both layers (e.g., the exposed surfaces) will become hydrophilic. But this hydrophilicity can be reversed in most cases by annealing the substrate at higher temperature (70° C. to 150° C.) for a short period of time (one to several minutes) and this depends on the chemistry of the material used. The hydrophobicity and hydrophilicity of the resist material can be adjusted by adding appropriate chemicals for this purpose.

The carrier liquid (hydrophobic/hydrophilic) can be chosen depending upon the structures, chemistry of the coating layers, surface chemistry, surface energy, and pattern design so that when the 1D NM dispersion is disposed on the surface, the dispersion will de-wet on to the patterned trenches or patterned pillars (or preferentially wet on patterned location). The 1D NMs will assemble and align on locations as shown in FIG. 9A or 9B. In this case, the difference in the surface energy of the layers causes the dispersion to preferentially wet on the grating surface. This will enable assembling the 1D NM in predetermined locations and, thereafter, the evaporation at elevated temperature on the patterns will orient the 1D NMs. In this way, the 1D NM's can be assembled, precisely positioned and aligned/oriented on any substrate of choice. The method is fully compatible with roll-to-roll or reel-to-reel (R2R) techniques and processes.

The bilayer approach can be extended to single layer also (only one layer on substrate). In this case, the RIE can expose and transfer the patterns in the trenches to the substrate and then stop etching (making sure the top layer still present on the substrate and covers the rest of the area). Annealing can make the top layer hydrophobic again (FIG. 9A)/hydrophilic again (FIG. 9B). If the selected substrate material is hydrophilic, it will remain hydrophilic after annealing (FIG. 9A). If the substrate material is hydrophobic, then annealing will make it hydrophobic again after RIE process (FIG. 9B).

In the bilayer and single layer approach, the top layer material can be chosen in such a way that it can be selectively removed after imprint, pattern transfer via RIE/other similar process, assembly, and alignment, using a suitable solvent. This will remove any randomly oriented 1D NMs left on the surface and will result in only the aligned 1D NMs assembled in the trenches to remain on the substrate. This will enable transferring the aligned assembly on to a different substrate of choice as well.

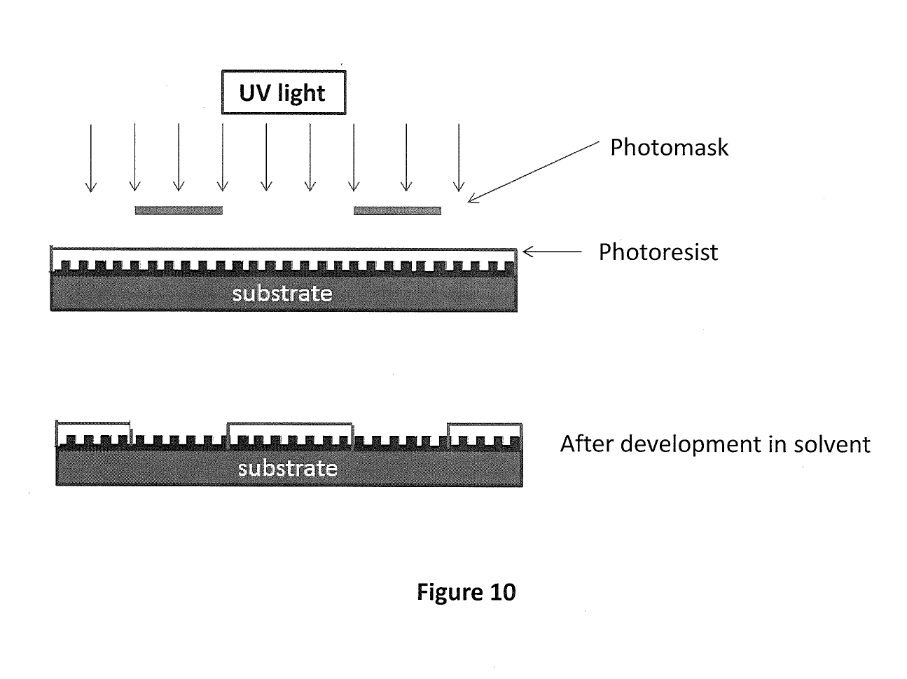

Photolithography can be done on nanoimprinted substrate as shown in FIG. 10. A hydrophobic photoresist can be deposited on the nanopatterned surface. A 3D structure can be generated after UV exposure and removal of the unexposed photoresist. Photolithography and other similar techniques can be used to generate 3D structures on nanopatterned surfaces. The 1D NMs can be assembled, positioned and aligned in the trenches, and the orientation of the 1D NMs depends on the direction of the channels as detailed above.

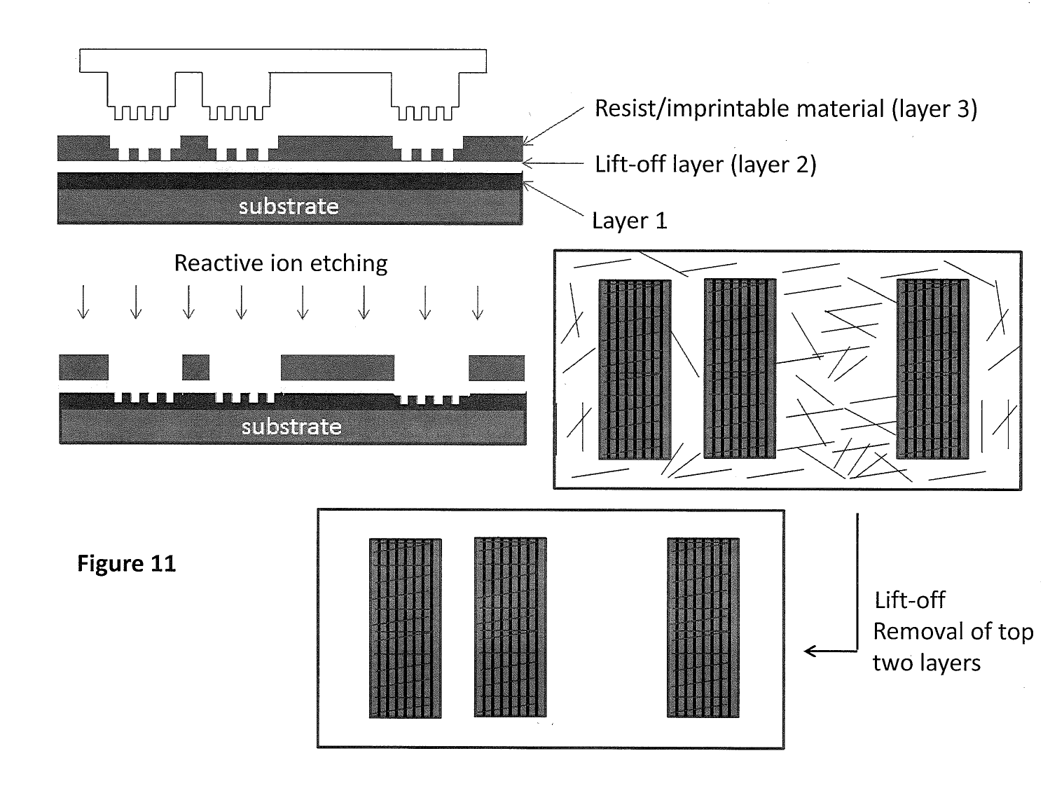

In yet another embodiment, three layers (a trilayer approach) may be used in conjunction with a master mold. In this approach, the chemistry of the layers may or may not be significant. After depositing the first layer of resist material on the substrate, a lift-off material is deposited on top of it as second layer. Finally, a resist material is deposited on top of the lift-off layer as third layer. This layer is patterned by using a mold having 3D features on it as shown in FIG. 11. After patterning, the substrate is subjected to anisotropic etch process using reactive ion etching (RIE). The anisotropic etching process is continued until the pattern on trench of the top layer is transferred to the bottom layer (see FIG. 11). Once the pattern is generated on the bottom layer in this way, the etching can be stopped. Afterwards, the 1D NM dispersion can be disposed on the substrate. The 1D NMs will be deposited all over the surface and at the same time will be assembled and aligned in the trenches according to the direction of the underlying channels. The rest of the randomly oriented 1D NMs lying on the top surface and sidewalls of the trenches can be removed by dissolving the lift-off layer using a suitable solvent. The solvent to dissolve the lift-off layer to remove the top two layers can be selected carefully so that it will not attack the patterned layer. Thereafter, only the aligned 1D NMs will remain on the substrate surface. Thus, controlled assembly, precise positioning and orientation of 1D NMs can be achieved by utilizing the invented alignment technique. The 1D NMs that are assembled, precisely positioned and oriented in this way can be transferred to another substrate of choice via transfer printing process.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method comprising:
dispersing one-dimensional objects in a liquid to form a mixture; and
disposing the mixture on a substrate that has channels disposed on it; where the channels are of a width of 2 to 90 percent of the length of the one-dimensional object.

2. The method of claim 1, further comprising disposing the channels on the substrate; and where the channels are disposed on the substrate by nanoimprinting, roll-to-roll ultraviolet nanoimprinting, laser printing, embossing, lithography followed by etching, self-assembly of a copolymer followed by etching; photolithography followed by etching; surface wrinkling, creasing or buckling, nano-scribing, scratching, shadow deposition, transfer printing, interference lithography, immersion lithography, atomic force microscopy lithography, e-beam lithography, nano-scribing, or a combination thereof.

3. The method of claim 1, where the liquid in the mixture is 50 to 10000 weight percent of the weight of the one-dimensional objects.

4. The method of claim 1, where the liquid is polar.

5. The method of claim 1, where the liquid is non-polar.

6. The method of claim 1, where the one-dimensional object is a nanotube, nanowire, nanorod, whisker, microtube, microwire, microrod, or combinations thereof.

7. The method of claim 1, where the one-dimensional objects are inorganic materials.

8. The method of claim 1, where the one-dimensional objects are organic materials.

9. The method of claim 7, where the inorganic one-dimensional object is selected from the group consisting of elemental metals, metal alloys, metal oxides, metal sulfides, metal nitrides, metal borides, metal silicides, metal phosphides, metal carbides, or a combination comprising at least one of the foregoing inorganic materials.

10. The method of claim 1, where the one-dimensional object is selected from the group consisting of carbon nanotubes, carbon nanotubes having pendant organic or inorganic substituents, nucleic acids, polymeric fibers, nanotubes or nanowires or nanorods comprising molybdenum, silicon, boron nitride, tungsten disulfide, tin disulfide, vanadium oxide, aluminum oxide, titanium oxide, zinc oxide, manganese oxide, transition metal/chalcogen/halogenides having the formula TM₆C_{y}H_{z}, where TM is a transition metal, C is a chalcogen, H is halogen and where 8.2<(y+z)<10, polyacetylene nanowires or microwires, polyacrylate nanowires or microwires, polyester nanowires or microwires, polystyrene nanowires or microwires, polycarbonate nanowires or microwires, polyimide nanowires or microwires, polyetherimide nanowires or microwires, polyetheroxide nanowires or microwires, polyether ketone nanowires or microwires, polysiloxane nanowires or microwires, polyfluoroethylene nanowires or microwires, cellulose nanowires or microwires, or combinations thereof.

11. The method of claim 1, where the liquid is selected from the group consisting of water, alcohols, ketones, glycol ethers, propylene carbonate, ethylene carbonate, butyrolactone, acetonitrile, benzonitrile, nitromethane, nitrobenzene, sulfolane, dimethylformamide, dimethylacetamide, N-methylpyrrolidone, nitromethane, methanol, ethanol, propanol, isopropanol, butanol, benzene, toluene, methylene chloride, carbon tetrachloride, hexane, diethyl ether, tetrahydrofuran, or combinations thereof.

12. The method of claim 1, further comprising drying the substrate.

13. The method of claim 1, further comprising preheating the substrate and drying the substrate.

14. An article comprising:
a substrate; where the substrate has channels disposed thereon; each channel being bounded by a wall; and
a plurality of one-dimensional objects that are oriented relative to the walls on the substrate; and where the channels are of a width of 2 to 90 percent of the smallest length of the plurality of one-dimensional objects.

15. The article of claim 14, where the one-dimensional object is a nanotube, nanowire, nanorod, whisker, microtube, microwire, microrod, or combinations thereof.

16. The article of claim 14, where the one-dimensional objects are inorganic materials.

17. The article of claim 14, where the one-dimensional objects are organic materials.

18. The article of claim 16, where the inorganic one-dimensional object is selected from the group consisting of elemental metals, metal alloys, metal oxides, metal sulfides, metal nitrides, metal borides, metal silicides, metal phosphides, metal carbides, or a combination comprising at least one of the foregoing inorganic materials.

19. The article of claim 14, where the one-dimensional object is selected from the group consisting of carbon nanotubes, carbon nanotubes having pendant organic or inorganic substituents, nucleic acids, polymeric fibers, nanotubes or nanowires or nanorods comprising molybdenum, silicon, boron nitride, tungsten disulfide, tin disulfide, vanadium oxide, aluminum oxide, titanium oxide, zinc oxide, manganese oxide, transition metal/chalcogen/halogenides having the formula TM6CyHz, where TM is a transition metal, C is a chalcogen, H is halogen and where 8.2<(y+z)<10, polyacetylene nanowires or microwires, polyacrylate nanowires or microwires, polyester nanowires or microwires, polystyrene nanowires or microwires, polycarbonate nanowires or microwires, polyimide nanowires or microwires, polyetherimide nanowires or microwires, polyetheroxide nanowires or microwires, polyether ketone nanowires or microwires, polysiloxane nanowires or microwires, polyfluoroethylene nanowires or microwires, cellulose nanowires or microwires, or combinations thereof.

20. The article of claim 14, where the substrate comprises a polymer.

21. The article of claim 14, where the substrate comprises a silicon wafer, glass, oxides, metal, paper, ceramic, composites, clothes, and the like.

22. The article of claim 14, where the one-dimensional objects are fused together.

23. The article of claim 14, where the one-dimensional objects are fused to the substrate.

24. The article of claim 14, where the one-dimensional objects are oriented approximately perpendicular to the walls.

25. The article of claim 14, where the substrate with the channels disposed thereon is naturally occurring.

26. A method comprising:
dispersing one-dimensional objects in a liquid to form a mixture; and
disposing the mixture on a first substrate that has channels disposed on it; each channel being bounded by pair of walls that are substantially parallel to each other at a first distance “x”;
collecting one-dimensional objects that are not contained in the channels from the first substrate;
disposing the one-dimensional objects so collected onto a second substrate that has channels disposed on it; each channel being bounded by pair of walls that are substantially parallel to each other at a first distance “y”; where y is greater than x; and
collecting one-dimensional objects that are not contained in the channels from the second substrate.

27. The method of claim 26, further comprising collecting the one-dimensional objects contained in the channels of the first substrate separately from the one-dimensional objects contained in the channels of the second substrate.

28. A method of manufacturing a device comprising:
disposing a first layer on a substrate;
imprinting on the first layer a plurality of channels that are parallel to one another; each channel being bounded by pair of walls that are substantially parallel to each;
dispersing a one-dimensional object in a liquid to form a mixture; and
disposing the mixture on the first layer in a manner such that the one-dimensional objects are located in precisely desired positions on the first layer;

29. The method of claim 28, further comprising a second layer that contacts the first layer.

30. The method of claim 29, where the first layer is hydrophobic and the second layer is hydrophilic.

31. The method of claim 29, where the first layer is hydrophilic and the second layer is hydrophobic.

32. The method of claim 28, further disposing a photoresist on the device and etching a portion of the device prior to disposing the mixture on the first layer.

33. The method of claim 28, where the channels are disposed on the first layer by nano imprinting, roll-to-roll ultraviolet nano imprinting, laser printing, embossing, lithography, or a combination thereof.

34. The method of claim 32, where the etching comprises reactive ion etching, chemical etching, plasma etching or a combination thereof.

35. The method of claim 28, where the one-dimensional object is a nanotube, nanowire, nanorod, whisker, microtube, microwire, microrod, or combinations thereof.

36. The method of claim 28, where the one-dimensional objects are inorganic materials.

37. The method of claim 28, where the one-dimensional objects are organic materials.

38. The method of claim 36, where the inorganic one-dimensional object is selected from the group consisting of elemental metals, metal alloys, metal oxides, metal sulfides, metal nitrides, metal borides, metal silicides, metal phosphides, metal carbides, or a combination comprising at least one of the foregoing inorganic materials.

39. The method of claim 29, further comprising a third layer that contacts the second layer.

39. The method of claim 28, where the one-dimensional object is selected from the group consisting of carbon nanotubes, carbon nanotubes having pendant organic or inorganic substituents, nucleic acids, polymeric fibers, nanotubes or nanowires or nanorods comprising molybdenum, silicon, boron nitride, tungsten disulfide, tin disulfide, vanadium oxide, aluminum oxide, titanium oxide, zinc oxide, manganese oxide, transition metal/chalcogen/halogenides having the formula TM₆C_{y}H_{z}, where TM is a transition metal, C is a chalcogen, H is halogen and where 8.2<(y+z)<10, polyacetylene nanowires or microwires, polyacrylate nanowires or microwires, polyester nanowires or microwires, polystyrene nanowires or microwires, polycarbonate nanowires or microwires, polyimide nanowires or microwires, polyetherimide nanowires or microwires, polyetheroxide nanowires or microwires, polyether ketone nanowires or microwires, polysiloxane nanowires or microwires, polyfluoroethylene nanowires or microwires, cellulose nanowires or microwires, or combinations thereof.
